(19) United States
(12) Patent Application Publication
(10) Pub. No.: US 2006/0294401 A1
(43) Pub. Date: Dec. 28, 2006

(54) Power management of multiple processors

(75) Inventor: William C. Munger, Austin, TX (US)

Correspondence Address: BAKER BOTTS, LLP, 910 LOUISIANA, HOUSTON, TX, 77002-4995, US

(73) Assignee: Dell Products L.P.

(21) Appl. No.: 11/165,880

(22) Filed: Jun. 24, 2005

(51) Int. Cl. G06F 1/26

(52) U.S. Cl. 713/300

(57) ABSTRACT

An information handling system having a plurality of physical processors capable of operating in either a low power or a high power state, and capable of running logical processors that may execute program threads. Each program thread is assigned to be executed in a respective logical processor. The assignment of each program thread to the respective logical processor is determined by whether the program thread requires high-utilization or low-utilization of the plurality of physical processors in the information handling system. To conserve power in the information handling system, high-utilization program threads are assigned to be executed in logical processors running in as few physical processors operating in the high power state, and low-utilization program threads are assigned to physical processors operating in the low power state. To maximize execution speed of program threads in the information handling system, high-utilization program threads are assigned to be executed in logical processors running in different physical processors operating in the high power state, and low-utilization program threads are assigned to any physical processor.

### TECHNICAL FIELD

The present disclosure relates generally to information handling systems, and more particularly, to power management of multiple processors in the information handling system.

### BACKGROUND

As the value and use of information continues to increase, individuals and businesses seek additional ways to process and store information. One option available to users are information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems, e.g., computer, personal computer workstation, portable computer, computer server, print server, network router, network hub, network switch, storage area network disk array, RAID disk system and telecommunications switch.

An information handling system may comprise a plurality of digital processors, e.g., microprocessors. These digital processors (hereinafter “processors”) are able to switch between different clock frequencies and operating voltages with negligible impact to software running on these processors. An operating system may conserve power in the information handling system by operating at least one of the plurality of processors at a lower clock frequency and/or operating voltage when at least one processor is not being fully utilized.

Each of the plurality of processors (hereinafter “physical processors”) may operate as a plurality of “logical processors.” This is referred to as “Hyperthreading.” However, when switching operating voltages, e.g., power state, of each physical processor all of the logical processors associated with that physical processor must operate under the same power state because each physical processor has only one set of power state registers.

For example, an information handling system may have two Hyperthreading physical processors where each of these physical processors has two power states, e.g., low-power and high-power. An operating system controlling the two physical processors must execute three threads (program instruction steps) at once, two of these threads require high processor utilization (high power operation) and the third thread only requires low processor utilization (low power operation). Conservation of power is of prime importance, e.g., portable battery operation.

Since the operating system is not aware of what logical processor is associated with which physical processor, the operating system may assign a high-utilization thread and a low-utilization thread to one physical processor, and the remaining high-utilization thread to the other physical processor. This scenario would require that both physical processors are operating in a high power state.

What would be preferred in order to conserve power would be for the two high-utilization threads to run on one physical processor operating in the high power state and the low-utilization thread to run on the other physical processor that may now operate in the low power state.

### SUMMARY

If the operating system would know the logical-to-physical processor mapping, it could have assigned the high-utilization threads to respective logical processors that were associated with just one physical processor running in the high power state, and the remaining low-utilization thread to a respective logical processor that was associated with the other physical processor that need only run in the low power state. Thus power would be conserved without sacrificing performance.

Conversely, if maximum operating performance was desired, e.g., power consumption was not of primary concern, then assigning only one high-utilization thread to each physical processor and running both of these physical processors in the high power state would be more desirable. Running each high-utilization thread on different physical processors may increase performance of the information handling system. Thus for a best performance, assigning each high-utilization thread to an associated logic processor running on difference physical processors will yield best performance. Since each of the physical processors is now running in the high power state. The low-utilization thread may be assigned to any logical processor running on either one of the physical processors.

A thread may change from high-utilization to low-utilization, or visa-versa, while it is executing. For example, a thread may use a processor less when it is accessing I/O devices (disk, network, etc.), and then it would use a processor more when it is performing arithmetic on data. Suppose a thread alternates between reading data from the network for a time (low-utilization) and then performing calculations on that data for a subsequent time (high-utilization). The operating system may re-assign the thread to different physical processors while the thread is executing in response to the changes in its utilization requirements.

According to specific example embodiments of this disclosure, a logical-to-physical mapping may be implemented by using an Advanced Configuration and Power Interface (ACPI) object, in accordance with the ACPI Specification, Revision 3, which is hereby incorporated by reference herein for all purposes. The “_PSD” (P-State Dependency) object may be used to notify the operating system which logical processors are mapped to the same “domain.” Each of the logical processors in a domain shares a dependency with the other logical processors in that domain. A domain may be defined as a physical processor and/or a plurality of physical processors, each domain having a certain power state. Thus, the operating system may have knowledge of which logical processors are associated with each physical processor (domain). The operating system also may know and be able to control the power state for each physical processor. Thus, the information handling system may be configured for optimum low power use, or optimum performance when power use is not of primary concern.

An information handling system for reducing power use during execution of program threads, according to a specific example embodiment of this disclosure, comprises: a plurality of physical processors, wherein each of the plurality of physical processors is capable of operating in either a low power or a high power state, and each of the plurality of physical processors is capable of running logical processors; and an operating system for controlling program thread execution by the logical processors running in the plurality of physical processors, wherein the operating system assigns execution of high-utilization program threads to the logical processors running in ones of the plurality of physical processors operating in the high power state and assigns execution of low-utilization program threads to the logical processors running in other ones of the plurality of physical processors operating in the low power state.

An information handling system for maximizing execution speed of program threads, according to another specific example embodiment of this disclosure, comprises: a plurality of physical processors, wherein each of the plurality of physical processors is capable of operating in either a low power or a high power state, and each of the plurality of physical processors is capable of running logical processors; and an operating system for controlling program thread execution by the logical processors running in the plurality of physical processors, wherein the operating system assigns execution of high-utilization program threads to the logical processors running in different ones of the plurality of physical processors operating in the high power state.

An information handling system having selectable high speed and low power system modes for executing program threads, according to yet another specific example embodiment of this disclosure, comprises: a plurality of physical processors, wherein each of the plurality of physical processors is capable of operating in either a low power or a high power state, and each of the plurality of physical processors is capable of running logical processors; and an operating system for controlling program thread execution by the logical processors running in the plurality of physical processors, wherein when running in a low power system mode the operating system assigns execution of high-utilization program threads to the logical processors running in ones of the plurality of physical processors operating in the high power state and assigns execution of low-utilization program threads to the logical processors running in other ones of the plurality of physical processors operating in the low power state, and when running in a high speed system mode the operating system assigns execution of high-utilization program threads to the logical processors running in different ones of the plurality of physical processors operating in the high power state.

A method for reducing power use during execution of program threads in an information handling system, according to still another specific example embodiment of this disclosure, comprises: running logical processors in a plurality of physical processors, wherein each of the plurality of physical processors is capable of operating in either a low power or a high power state; executing high-utilization program threads with the logical processors running in ones of the plurality of physical processors operating in the high power state; and executing low-utilization program threads with the logical processors running in other ones of the plurality of physical processors operating in the low power state.

A method for maximizing execution speed of program threads in an information handling system, according to another specific example embodiment of this disclosure, comprises: running logical processors in a plurality of physical processors, wherein each of the plurality of physical processors is capable of operating in either a low power or a high power state; executing high-utilization program threads with the logical processors running in different ones of the plurality of physical processors operating in the high power state; and executing low-utilization program threads with the logical processors running in any ones of the plurality of physical processors.

### BRIEF DESCRIPTION OF THE DRAWINGS

A more complete understanding of the present disclosure thereof may be acquired by referring to the following description taken in conjunction with the accompanying drawings wherein:

FIG. 1 is a schematic block diagram of an information handling system, according to specific example embodiments of the present disclosure;

FIG. 2 is a schematic block diagram of a plurality of logical processors running in associated physical processors;

FIG. 3 is a schematic block diagram of a plurality of program threads running in associated logical processors selected for minimum power operation, according to a specific example embodiment of the present disclosure; and

FIG. 4 is a schematic block diagram of a plurality of program threads running in associated logical processors selected for maximum program execution speed, according to another specific example embodiment of the present disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU), hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring now to the drawings, the details of specific example embodiments are schematically illustrated. Like elements in the drawings will be represented by like numbers, and similar elements will be represented by like numbers with a different lower case letter suffix.

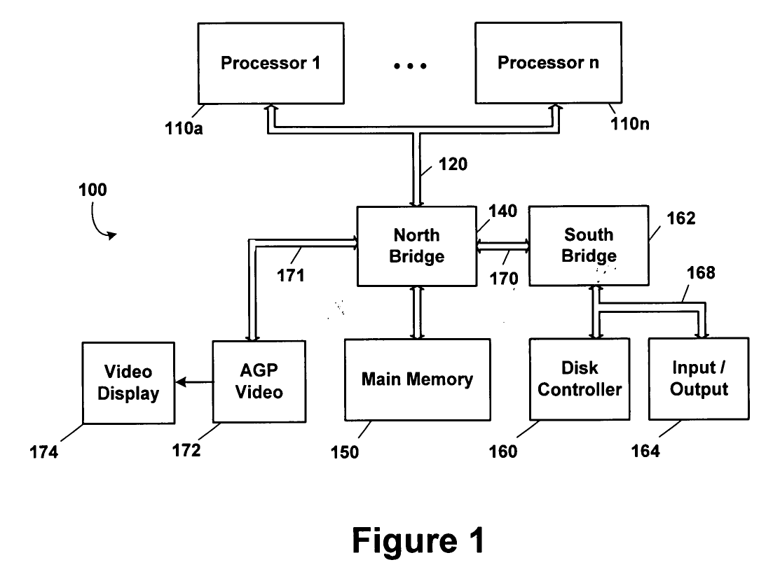

Referring to FIG. 1, depicted is an information handling system having electronic components mounted on at least one printed circuit board (PCB) (motherboard) and communicating data and control signals therebetween over signal buses, according to a specific example embodiment of the present disclosure. In one example embodiment, the information handling system is a computer system. The information handling system, generally referenced by the numeral 100, comprises a plurality of physical processors 110, generally represented by processors 110a-110n, coupled to a host bus(es) 120. A north bridge 140, which may also be referred to as a memory controller hub or a memory controller, is coupled to a main system memory 150. The north bridge 140 is coupled to the plurality of processors 110 via the host bus(es) 120. The north bridge 140 is generally considered an application specific chip set that provides connectivity to various buses, and integrates other system functions such as a memory interface. For example, an Intel 820E and/or 815E chip set, available from the Intel Corporation of Santa Clara, Calif., provides at least a portion of the north bridge 140. The chip set may also be packaged as an application specific integrated circuit (ASIC). The north bridge 140 typically includes functionality to couple the main system memory 150 to other devices within the information handling system 100. Thus, memory controller functions such as main memory control functions typically reside in the north bridge 140. In addition, the north bridge 140 provides bus control to handle transfers between the host bus 120 and a second bus(es), e.g., PCI bus 170, AGP bus 171 coupled to a video graphics interface 172 which drives a video display 174. A third bus(es) 168 may also comprise other industry standard buses or proprietary buses, e.g., ISA, SCSI, I²C, SPI, USB buses through a south bridge(s) (bus interface) 162. A disk controller 160 and input/output interface 164 may be coupled to the third bus(es) 168.

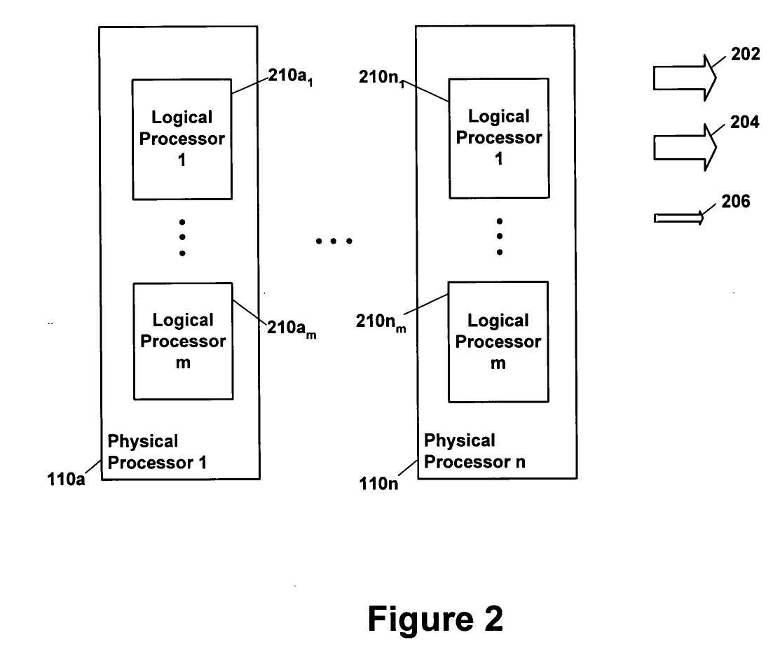

Referring to FIG. 2, depicted is a schematic block diagram of a plurality of logical processors running in associated physical processors. Each of the physical processors 110 may have a plurality of logical processors 210 running concurrently therein. This allows each of the plurality of logical processors 210 to execute a different program thread substantially concurrently. Each of the physical processors 110 may operate under different conditions, e.g., voltage, current, clock frequencies, etc., however, all logical processors 210 associated with a physical processor 110 will perform the same based upon that physical processor 110 operating parameters, e.g., low or high power states.

When a physical processor 110 is in a high power state, program (thread) execution by the associated logical processors 210 may perform at higher throughputs than when the physical processor 110 is in a low power state. For example, when a high-utilization thread is executed in a physical processor that is running at higher frequencies/voltages there is a noticeable performance enhancement to a user. However, when a low-utilization thread is executed in a physical processor that is running at higher frequencies/voltages there is negligible performance improvement to the user. Therefore, program threads 202 and 204 are high-utilization threads that may be preferably processed with logical processors 210 running in a physical processor 110 operating in the high power state, e.g., at higher clock frequencies and/or voltages. Program thread 206 is a low-utilization thread that may be adequately processed with a logical processor 210 running in a physical processor 110 operating in the low power state, e.g., at lower clock frequencies and/or voltages.

A thread may change from high-utilization to low-utilization, or visa-versa, while it is executing, e.g., if all threads become low utilization then the operating system may switch all physical processors to the low power state. For example, a thread may use a processor less when it is accessing I/O devices (disk, network, etc.), and then it would use a processor more when it is performing arithmetic on data. Suppose a thread alternates between reading data from the network for a time (low-utilization) and then performing calculations on that data for a subsequent time (high-utilization). The operating system may re-assign the thread to different physical processors while the thread is executing in response to the changes in its utilization requirements.

A logical-to-physical mapping for each logical processor 210 and physical processor 110 may be implemented by using an Advanced Configuration and Power Interface (ACPI) object, in accordance with the ACPI Specification, Revision 3, which is hereby incorporated by reference herein for all purposes. A P-State Dependency (“_PSD”) object may be used to notify the operating system which logical processors 210 are mapped to the same physical processor(s) 110, e.g., “domain(s).” The _PSD object corresponds to multiple states of the processor, e.g., provides processor power state control information to the program operating system. The _PSD object may evaluate to a packaged list of information that correlates with power state information of the physical processors 110 (e.g., domains). Each packaged list entry may identify a dependency domain number for the power states associated with each logical processor 210, the coordination type for those power states and the number of logical processors belonging to a domain. The operating system may then assign program threads based upon each program thread's utilization requirement and available logical processors 210 running in a physical processor operating in an appropriate power state.

Each of the logical processors of a physical processor domain shares a dependency with the other logical processors 210 in that physical processor domain, e.g., when a physical processor domain changes power states, all logical processors 210 within that physical processor domain change to that domain power state. A physical processor domain may be defined as one physical processor 110 and/or a plurality of physical processors 110, each domain having a certain power state. Thus, the operating system may have knowledge of which logical processors 210 are associated with each physical processor 110 (domain). The operating system also may know and be able to control the power state for each physical processor 110. Thus, the information handling system may be configured for optimum low power use, or optimum performance when power use is not of primary concern.

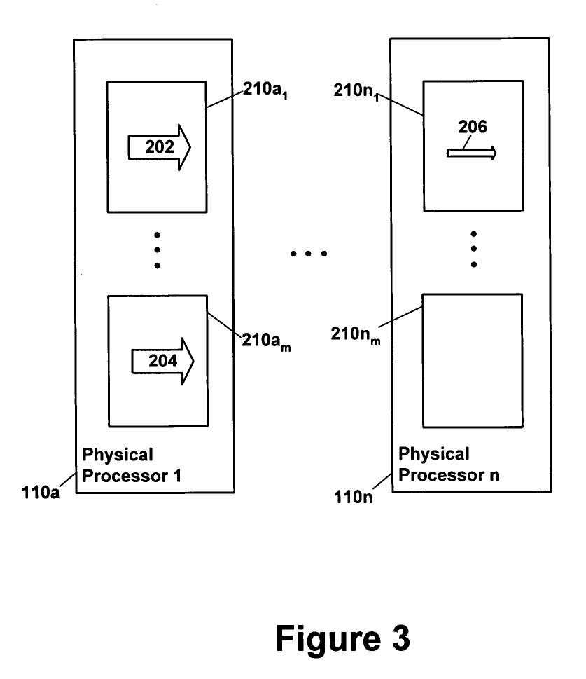

Referring now to FIG. 3, depicted is a schematic block diagram of a plurality of program threads running in associated logical processors selected for minimum power operation, according to a specific example embodiment of the present disclosure. Program threads 202 and 204 are being executed in logical processors 210a that are running in associated physical processor 110a. The physical processor 110a is operating in the high power state and the high-utilization program threads 202 and 204 are being processed at substantially maximum throughputs for two concurrently running high-utilization program threads. Since the low-utilization program thread 206 does not require high throughput for proper execution, a logical processor 210n running in a physical processor 110n operating in the low power state is adequate. By assigning the two high-utilization program threads 202 and 204 to logical processors 210a running in the same physical processor 110a, and assigning the low-utilization thread 206 to a logical processor 210n running in a different physical processor 110n, only the physical processor 110a need be in the high power state. The other physical processor 110n can remain in a low power state, thus conserving power in the information handling system 100.

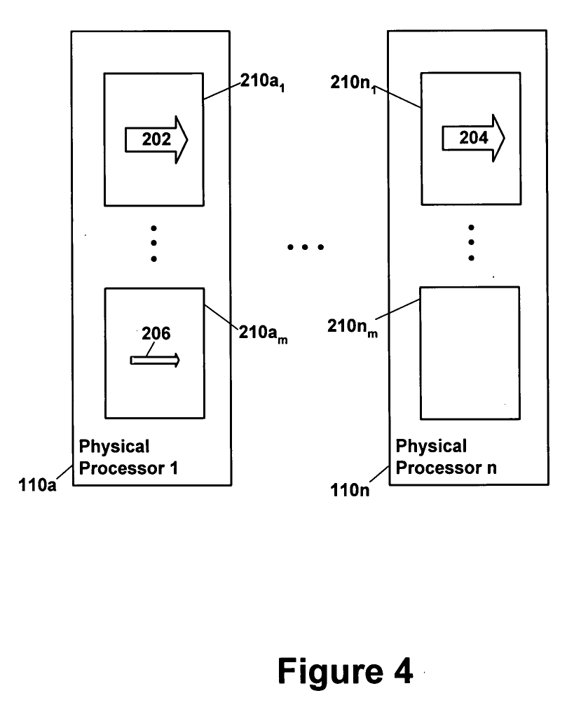

Referring to FIG. 4, depicted is a schematic block diagram of a plurality of program threads running in associated logical processors selected for maximum program execution speed, according to another specific example embodiment of the present disclosure. Program thread 202 is being executed in a logical processor 210a and program thread 204 is being executed in a logical processor 210n. The logical processor 210a is running in the physical processor 110a and the logical processor 210n is running in the physical processor 110n. Both physical processors 110a and 110n are operating in the high power state. The program thread 206 may be executed in either one of the logical processors 210a or 210n (processor 210a shown). Therefore since thread 206 is a low-utilization program thread, it may not substantially affect execution speeds of the logical processors 210 running in the associated physical processor 110. By assigning each of the high-utilization program threads 202 and 204 to individual logical processors 210 running in different physical processors 110, and assigning the low-utilization thread 206 to a logical processor 210 running in either one of the physical processors 110, maximum program throughput will be achieved in the information handling system 100.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. An information handling system for reducing power use during execution of program threads, said system comprising:
a plurality of physical processors, wherein each of the plurality of physical processors is capable of operating in either a low power or a high power state, and each of the plurality of physical processors is capable of running logical processors; and
an operating system for controlling program thread execution by the logical processors running in the plurality of physical processors, wherein the operating system assigns execution of high-utilization program threads to the logical processors running in ones of the plurality of physical processors operating in the high power state and assigns execution of low-utilization program threads to the logical processors running in other ones of the plurality of physical processors operating in the low power state.

2. The information handling system according to claim 1, wherein the high power state comprises a plurality of high power states.

3. The information handling system according to claim 1, wherein the low power state comprises a plurality of low power states.

4. The information handling system according to claim 1, wherein the operating system discovers the power state of each one of the plurality of physical processors.

5. The information handling system according to claim 1, wherein the operating system controls the power state of each one of the plurality of physical processors.

6. The information handling system according to claim 1, wherein the operating system discovers which ones of the logical processors are associated with each one of the plurality of physical processors.

7. The information handling system according to claim 1, wherein the operating system controls the power state of each one of the plurality of physical processors based upon how many high-utilization program threads and low-utilization program threads are being executed.

8. The information handling system according to claim 4, wherein the logical processors are assigned to domains and each of the domains represents one of the plurality of physical processors.

9. The information handling system according to claim 1, wherein the high-utilization program threads are assigned to logical processors running in physical processors operating in the high power state before the low-utilization program threads are assigned.

10. The information handling system according to claim 9, wherein the logical processors executing the high-utilization program threads are selected so as to minimize the number of physical processors required to operate in the high power state.

11. The information handling system according to claim 1, wherein when a high-utilization program thread becomes a low-utilization program thread the operating system reassigns execution thereof to one of the plurality of physical processors operating in the low power state.

12. The information handling system according to claim 1, wherein when a low-utilization program thread becomes a high-utilization program thread the operating system reassigns execution thereof to one of the plurality of physical processors operating in the high power state.

13. An information handling system for maximizing execution speed of program threads, said system comprising:
a plurality of physical processors, wherein each of the plurality of physical processors is capable of operating in either a low power or a high power state, and each of the plurality of physical processors is capable of running logical processors; and
an operating system for controlling program thread execution by the logical processors running in the plurality of physical processors, wherein the operating system assigns execution of high-utilization program threads to the logical processors running in different ones of the plurality of physical processors operating in the high power state.

14. The information handling system according to claim 13, wherein the high power state comprises a plurality of high power states.

15. The information handling system according to claim 13, wherein the low power state comprises a plurality of low power states.

16. The information handling system according to claim 13, wherein the operating system assigns execution of low-utilization program threads to logical processors running in any of the plurality of physical processors.

17. The information handling system according to claim 13, wherein the operating system discovers the power state of each one of the plurality of physical processors.

18. The information handling system according to claim 13, wherein the operating system controls the power state of each one of the plurality of physical processors.

19. The information handling system according to claim 13, wherein the operating system discovers which ones of the logical processors are associated with each one of the plurality of physical processors.

20. The information handling system according to claim 13, wherein the operating system controls the power state of each one of the plurality of physical processors based upon how many high-utilization program threads and low-utilization program threads are being executed.

21. The information handling system according to claim 13, wherein the high-utilization program threads are assigned to the logical processors running in different physical processors operating in the high power state before the low-utilization program threads are assigned.

22. The information handling system according to claim 13, wherein when a high-utilization program thread becomes a low-utilization program thread the operating system reassigns execution thereof.

23. The information handling system according to claim 13, wherein when a low-utilization program thread becomes a high-utilization program thread the operating system reassigns execution thereof.

24. An information handling system having selectable high speed and low power system modes for executing program threads, said system comprising:
a plurality of physical processors, wherein each of the plurality of physical processors is capable of operating in either a low power or a high power state, and each of the plurality of physical processors is capable of running logical processors; and
an operating system for controlling program thread execution by the logical processors running in the plurality of physical processors, wherein
when running in a low power system mode the operating system assigns execution of high-utilization program threads to the logical processors running in ones of the plurality of physical processors operating in the high power state and assigns execution of low-utilization program threads to the logical processors running in other ones of the plurality of physical processors operating in the low power state, and
when running in a high speed system mode the operating system assigns execution of high-utilization program threads to the logical processors running in different ones of the plurality of physical processors operating in the high power state.

25. The information handling system according to claim 23, wherein the high power state comprises a plurality of high power states.

26. The information handling system according to claim 23, wherein the low power state comprises a plurality of low power states.

27. The information handling system according to claim 23, wherein when a high-utilization program thread becomes a low-utilization program thread the operating system reassigns execution thereof.

28. The information handling system according to claim 23, wherein when a low-utilization program thread becomes a high-utilization program thread the operating system reassigns execution thereof.

29. The information handling system according to claim 23, wherein the operating system controls the power state of each one of the plurality of physical processors depending upon how many low-utilization and high utilization program threads are being executed.

30. A method for reducing power use during execution of program threads in an information handling system, said method comprising the steps of:
running logical processors in a plurality of physical processors, wherein each of the plurality of physical processors is capable of operating in either a low power or a high power state;
executing high-utilization program threads with the logical processors running in ones of the plurality of physical processors operating in the high power state; and
executing low-utilization program threads with the logical processors running in other ones of the plurality of physical processors operating in the low power state.

31. The method according to claim 29, further comprising the step of reassigning thread execution when a high-utilization program thread becomes a low-utilization program thread.

32. The method according to claim 29, further comprising the step of reassigning thread execution when a low-utilization program thread becomes a high-utilization program thread.

33. The method according to claim 29, further comprising the step of controlling the power state of each one of the plurality of physical processors depending upon how many low-utilization and high utilization program threads are being executed.

34. A method for maximizing execution speed of program threads in an information handling system, said method comprising the steps-of:
running logical processors in a plurality of physical processors, wherein each of the plurality of physical processors is capable of operating in either a low power or a high power state;
executing high-utilization program threads with the logical processors running in different ones of the plurality of physical processors operating in the high power state; and
executing low-utilization program threads with the logical processors running in any ones of the plurality of physical processors.

35. The method according to claim 33, further comprising the step of reassigning thread execution when a high-utilization program thread becomes a low-utilization program thread.

36. The method according to claim 33, further comprising the step of reassigning thread execution when a low-utilization program thread becomes a high-utilization program thread.

37. The method according to claim 33, further comprising the step of controlling the power state of each one of the plurality of physical processors depending upon how many low-utilization and high utilization program threads are being executed.
